(19) United States
(12) Patent Application Publication
(10) Pub. No.: US 2003/0090661 A1
(43) Pub. Date: May 15, 2003

(54) Focusing method, position-measuring method, exposure method, method for producing device, and exposure apparatus

(75) Inventor: Mitsuru Kobayashi, Kumagaya-shi (JP)

Correspondence Address: OLIFF & BERRIDGE, PLC, P.O. BOX 19928, ALEXANDRIA, VA, 22320, US

(73) Assignee: NIKON CORPORATION, Tokyo (JP)

(21) Appl. No.: 10/291,615

(22) Filed: Nov. 12, 2002

(30) Foreign Application Priority Data
Nov. 14, 2001 (JP) 2001-348978

(51) Int. Cl. G01B 11/00

(52) U.S. Cl. 356/400

(57) ABSTRACT

Highly accurate focus adjustment is realized at a high throughput irrelevant to reflection characteristics of a mask. A second optical system observes a first object and it is capable of observing a second object via the first object and a first optical system. A focusing position of the second optical system is adjusted to a predetermined plane on the first object. In Step S8, a predetermined plane on the second object is adjusted to a position which is optically conjugate with the predetermined plane on the first object with respect to the first optical system. In Step S10, the focusing position of the second optical system is adjusted to the predetermined plane on the second object via the first optical system.

### BACKGROUND OF THE INVENTION

1. Field of the Invention

The present invention relates to a focusing method for adjusting a focusing position of an optical system to a predetermined plane on an object, a position-measuring method for measuring position information about the object by using the optical system, an exposure method for exposing a substrate with a pattern on a mask on the basis of the measured position information, and a method for producing a device.

2. Related Art

A projection exposure apparatus has been heretofore used in order that an image of a device pattern on a photomask or a reticle (hereinafter generically referred to as “reticle”) is projected via a projection optical system onto respective shot areas on a photosensitive substrate, for example, when a semiconductor device or a liquid display device is produced by means of the photolithography step. The projection exposure apparatus of this type, which has been hitherto used, is often an exposure apparatus based on the so-called step-and-repeat system, for example, an exposure apparatus of the full field exposure type (stepper) in which a photosensitive substrate is placed on a two-dimensionally movable stage to repeat such an operation that the photosensitive substrate is moved in a stepping manner by using the stage to successively expose respective shot areas on the photosensitive substrate such as a wafer with an image of a pattern on the reticle. In recent years, an exposure apparatus of the scanning exposure type (scanner) based on the so-called step-and-scan system has been also used, in which the respective shot areas on the wafer are successively subjected to the exposure by synchronously scanning the reticle and the wafer during the exposure of the wafer.

For example, a microdevice such as a semiconductor device is formed by superimposing circuit patterns of a large number of layers on a wafer applied with a photosensitive material as a photosensitive substrate. Therefore, when the wafer is subjected to the projection exposure with the circuit pattern of the second layer or one of the following layers, it is necessary to accurately perform the positional adjustment for each of the shot areas on the wafer on which the circuit pattern has been already formed and the image of the pattern on the reticle to be subjected to the exposure from now on, i.e., the positional adjustment (alignment) for the wafer and the reticle.

Those having been investigated to be adopted for the positional adjustment for the reticle and the wafer as described above include various types of alignment sensors, for example, a sensor based on the off-axis system for measuring an alignment mark position by using an alignment optical system arranged in the vicinity of a projection optical system, and a sensor based on the so-called TTR (through the reticle) system for detecting a fiducial mark formed on a fiducial member provided on a wafer stage or an alignment mark formed on a wafer by the aid of a projection optical system and a reticle alignment mark formed on a reticle.

The TTR sensor is operated, for example, as follows. That is, the reticle alignment mark and the wafer alignment mark (or the fiducial mark) formed (observed) as an image via the projection optical system are photographed in a superimposed state in an identical field to measure any positional deviation amount between the marks. More particularly, a light beam having an exposure wavelength, which is introduced by an optical fiber, is reflected by an epi-reflection mirror installed over a reticle. The light beam is radiated onto a wafer via the reticle surface and the glass portion of the reticle. The light beams, which are reflected by the reticle surface and the wafer surface, are reflected by the epi-reflection mirror again, and they are introduced into various types of measuring sensors.

In this procedure, the position of the wafer (or the wafer stage) in the optical axis direction of the projection optical system is focused with the alignment optical system (and the projection optical system), and then the positional relationship between the mark on the reticle and the fiducial mark is measured. Accordingly, the reticle is positionally adjusted with respect to the wafer stage coordinate system which is the reference coordinate system of the exposure apparatus. Further, the positional relationship between the alignment mark on the reticle and the wafer alignment mark is measured. Accordingly, the reticle and the wafer are positionally adjusted. In this system, the reticle alignment mark and the wafer alignment mark are directly measured via the projection optical system. Therefore, the so-called baseline itself, which is the relative distance between the reticle center and the measurement center of the alignment sensor, is absent. Thus, it is possible to carry out the highly accurate position measurement (positional adjustment) without being exerted by any influence of thermal fluctuation or the like which would be otherwise feared to occur in the off-axis system.

In this procedure, the epi-reflection mirror of the alignment optical system is driven to an escape position during the exposure so that the exposure light beam to come into the projection optical system is not disturbed thereby. However, any deviation is brought about, for example, by any mechanical error of the driving mechanism every time when the mirror is driven from the escape position to the measuring position. As a result, the so-called defocus occurs, in which the focusing position of the alignment optical system is not coincident with the measuring plane on the reticle. As for the reticle to be measured, any dispersion in thickness exists between the reticles. Therefore, the position of the measuring plane on the reticle also varies depending on every reticle, which is a factor to cause the defocus. If the position measurement is carried out in such a defocus state, for example, any inconvenience arises such that the image becomes dull and the repeatability of the measurement is deteriorated.

In view of the above, in order to absorb the defocus amount as described above, an optical element, which is based on an internal focusing system, has been hitherto provided in a reticle alignment optical system. The focusing position of the alignment optical system is adjusted to the measuring plane of the reticle by driving the optical element along the optical axis.

A specified sequence will be explained with reference to a flow chart shown in FIG. 13. The reticle is loaded, for example, by means of reticle exchange (Step S1). When the epi-reflection mirror is driven from the escape position to the measuring position (Step S2), the wafer stage is firstly driven (Step S3) so that the underlying base, which has a reflectance (for example, 5%) greatly different from a reflectance (for example, 60%) of the reticle alignment mark, is disposed just under the alignment optical system in order not to lower the contrast during the measurement of the reticle alignment mark. Subsequently, the image of the reticle alignment mark formed on the reticle is detected with a sensor such as a CCD camera while driving (focusing) the optical element of the internal focusing system (Step S4). The change of the signal waveform is processed with an appropriate algorithm such as a differential process. Thus, the position at which the focusing position of the alignment optical system is coincident with the measuring plane on the reticle, i.e., the so-called best focus position F1 is calculated (Step S5). After the calculation of the best focus position, the optical element of the internal focusing system is driven to the focus position F1, and the focusing position of the alignment optical system is adjusted to the reticle measuring plane (Step S6). When the focus adjustment is completed for the alignment optical system, the reticle alignment is carried out in Step S7.

The focus adjustment for the alignment optical system is carried out at the following timing. That is, the focus adjustment is executed during the baseline measurement (hereinafter referred to as “baseline check”) after the reticle exchange, during the so-called interval baseline check to perform the baseline check in the middle of the process for a lot, and during the alignment for the reticle and the wafer.

However, the conventional technique as described above involves the following problems.

In the present circumstances, those used as the photomask include those which are conventionally subjected to the patterning with Cr (chromium) as well as those which are subjected to the patterning with half tone materials such as MoSi and ZrSi. When the best focus position is determined by using an alignment mark formed on the half tone reticle as described above, it has been difficult to correctly adjust the focus due to the deterioration of S/N, because the contrast of the signal differs depending on the reflectance of the photomask.

Conventionally, in order to solve this problem, several artifices are required as follows depending on the type of the photomask. That is, for example, when the photomask having a low reflectance is used, it is necessary to select a high reflectance part of the wafer stage for the underlying base. On the other hand, for example, when the photomask having a high reflectance is used, it is necessary to select a low reflectance part of the wafer stage for the underlying base. As a result, another problem arises such that the management is complicated.

Further, in the case of the method as described above, when the focus adjustment is performed for the alignment optical system, it is necessary that a specified mark corresponding to the reflectance of the photomask is positioned (on the underlying base) just under the alignment optical system on the side of the wafer stage. As a result, still another problem also arises such that the throughput is lowered in an amount corresponding to the driving of the wafer stage.

### SUMMARY OF THE INVENTION

The present invention has been made taking the foregoing points into consideration, an object of which is to provide a focusing method, a position-measuring method, an exposure method, and a method for producing a device, wherein the highly accurate focus adjustment can be realized irrelevant to reflection characteristics of a photomask. Another object of the present invention is to perform the focus adjustment at a high throughput.

In order to achieve the objects as described above, the present invention adopts the following construction correlated with FIGS. 1 to 9 which show an embodiment thereof.

According to the present invention, there is provided a focusing method for adjusting, to a first object (R), a focusing position of a second optical system (16) which observes the first object (R) and which is capable of observing a second object (18) via the first object (R) and a first optical system (9); the focusing method comprising a step (S9) of adjusting the second object (18) to a position which is optically conjugate with the first object (R) with respect to the first optical system (9); and a step (S6) of adjusting the focusing position of the second optical system (16) to the second object (18) via the first optical system (9).

Therefore, in the focusing method of the present invention, when the second object (18) is observed via the first optical system (9) to adjust the focusing position of the second optical system (16), the focusing position of the second optical system (16) can be indirectly adjusted to the first object (R) at the position which is optically conjugate with the second object (18). When a mark is formed on the second object (18), for example, with a material having a high reflectance such as Cr and a material having a low reflectance such as glass surface, a sufficient contrast is obtained without requiring any complicated management irrelevant to the reflection characteristics of the first object (R) such as a photomask. Thus, the focus adjustment for the second optical system (16) can be carried out highly accurately.

When relative position information about the second object (18) and a first reference member (24) is previously determined, and the first reference member (24) having a high reflectance is observed to adjust the focusing position of the second optical system (16), then the focus adjustment can be carried out irrelevant to the position of the second object (18). Accordingly, it is unnecessary to drive the second object (18). Thus, it is possible to improve the throughput.

According to another aspect of the present invention, there is provided a position-measuring method for measuring position information about a first object (R) by using a second optical system (16) which observes the first object (R) and which is capable of observing a second object (18, W) via the first object (R) and a first optical system (9); the position-measuring method comprising a step of adjusting the second object (18, W) to a position which is optically conjugate with the first object (R) with respect to the first optical system (9); and a step of adjusting a focusing position of the second optical system to the second object (18, W) via the first optical system (9).

Therefore, in the position-measuring method of the present invention, the focus adjustment for the second optical system (16) can be carried out without requiring any complicated management irrelevant to the reflection characteristics of the first object (R) such as a photomask. Thus, it is possible to avoid inconveniences which would be otherwise caused such that the repeatability of the measurement is deteriorated, for example, due to any dulled image caused by the defocus.

According to still another aspect of the present invention, there is provided an exposure method for performing exposure with a pattern (PT) formed on a first object (R) via a first optical system (9); the exposure method comprising a step of adjusting a second object (18, W) to a position which is optically conjugate with the pattern (PT) on the first object (R) with respect to the first optical system (9); and a step of adjusting a focusing position of a second optical system (16) which observes the first object (R) and which is capable of observing the second object (18, W) via the first object (R) and the first optical system (9), to the second object (18, W) via the first optical system (9).

Therefore, in the exposure method of the present invention, the focusing position of the second optical system (16) can be adjusted highly accurately without requiring any complicated management irrelevant to the reflection characteristics of the first object (R). Thus, the first object (R) can be observed without any defocus to perform the exposure.

According to still another aspect of the present invention, there is provided a method for producing a device by transferring a device pattern (PT) formed on a first object (R) via a first optical system (9); the method comprising a step of adjusting a second object (18, W) to a position which is optically conjugate with the first object (R) with respect to the first optical system (9); and a step of adjusting a focusing position of a second optical system (9) which observes the first object (R) and which is capable of observing the second object (18, W) via the first object (R) and the first optical system (9), to the second object (18, W) via the first optical system (9).

Therefore, in the method for producing the device of the present invention, the focusing position of the second optical system (16) can be adjusted highly accurately without requiring any complicated management irrelevant to the reflection characteristics of the mask (R). Thus, the first object (R) can be observed without any defocus to perform the exposure.

According to still another aspect of the present invention, there is provided an exposure apparatus (1) for performing exposure with a pattern (PT) formed on a first object (R) via a first optical system (9); the exposure apparatus comprising a second optical system (16) which observes the first object (R) and which is capable of observing a second object (18, W) via the first object (R) and the first optical system (9); a stage (10) which holds the second object (18, W) and which positions the second object (18, W) at a position conjugate with the first object (R) with respect to the first optical system (9); and an alignment control system (19) which adjusts a focusing position of the second optical system (16) to the second object (18, W).

Therefore, according to the exposure apparatus of the present invention, the focus adjustment for the second optical system (16) can be carried out highly accurately irrelevant to the reflection characteristics of the first object (R). Thus, the first object (R) can be observed without any defocus to perform the exposure.

Further, in the exposure apparatus of the present invention, the second optical system (16) may have an internal focusing system lens (53) which adjusts the focusing position of the second optical system, and an internal focusing system lens position-detecting unit (58) which detects a position of the internal focusing system lens; and the apparatus may further comprise a storage unit (21) which stores position data of the internal focusing system lens detected by the internal focusing system lens position-detecting unit.

Therefore, the focusing position of the second optical system (16) can be adjusted highly accurately. Further, the position can be stored, and the focusing position can be reproduced later on.

### BRIEF DESCRIPTION OF THE DRAWINGS

FIG. 1 shows an embodiment of the present invention, illustrating a schematic arrangement of an exposure apparatus.

FIG. 2 shows a plan view illustrating an example of an alignment mark formed on a reticle.

FIG. 3 shows a plan view illustrating an example of a fiducial mark, a reticle fiducial mark, and a wafer alignment mark.

FIG. 4 shows a schematic arrangement of an alignment sensor.

FIG. 5 shows a flow chart of Sequence A.

FIG. 6A shows an image pickup signal waveform of a single mark, and FIG. 6B shows a signal waveform obtained by differentiating and processing the image pickup signal shown in FIG. 6A.

FIG. 7 explains an algorithm for calculating the best focus position F1 from the focus signal waveform.

FIG. 8 shows an example of an image pickup signal of a mark image including a fiducial mark and a reticle alignment mark in combination.

FIG. 9 shows a flow chart of Sequence B at the beginning of a lot.

FIG. 10 shows a flow chart of Sequence B in the middle of the lot.

FIG. 11 shows a flow chart of Sequence C.

FIG. 12 shows a flow chart illustrating exemplary steps of producing a semiconductor device.

FIG. 13 shows a flow chart illustrating an example of the conventional focus adjustment for the alignment sensor.

### DESCRIPTION OF THE PREFERRED EMBODIMENTS

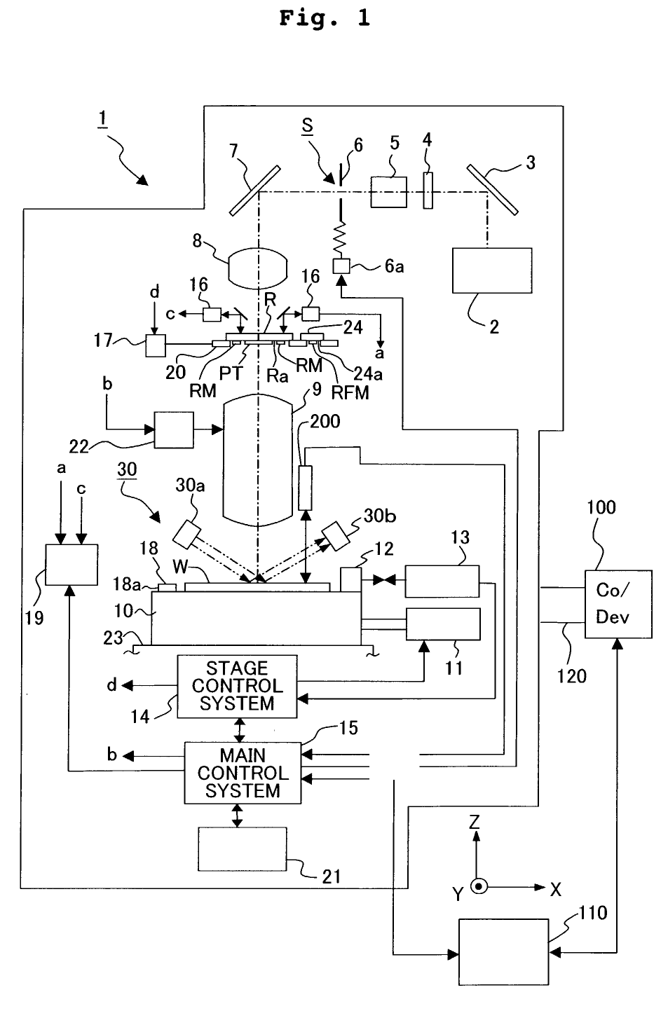

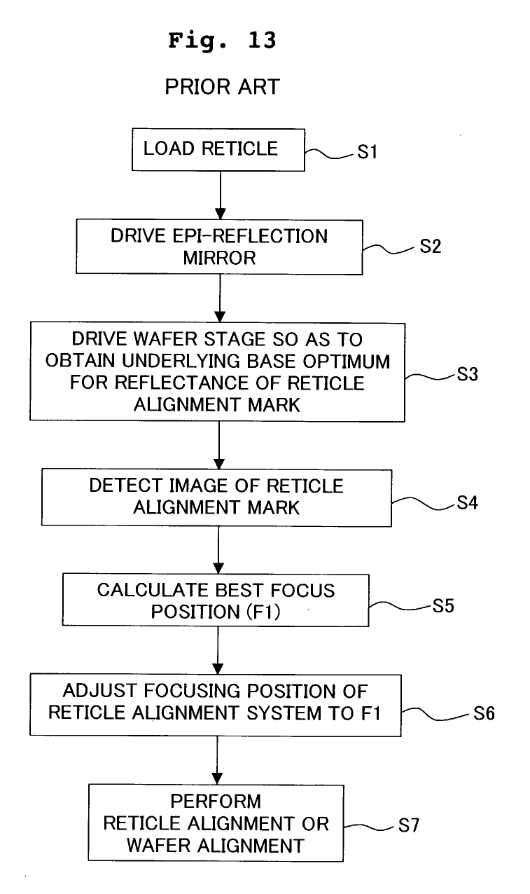

Embodiments of the focusing method, the position-measuring method, the exposure method, and the method for producing the device according to the present invention will be explained below with reference to FIGS. 1 to 9. In these figures, the same steps as those depicted in the flow chart shown in FIG. 13 having been described as the exemplary conventional technique are designated by the same reference symbols, explanation of which will be simplified. The description will be made herein as exemplified by a case in which a wafer for producing a semiconductor device is exposed with a device pattern on a reticle by using an exposure apparatus of the scanning exposure type. Further, the description will be made herein assuming that the focusing method and the position-measuring method of the present invention are used to adjust the focus for an alignment optical system based on the TTR system to be used for measuring the position of an alignment mark formed on the wafer when the reticle and the wafer are subjected to positional adjustment.

FIG. 1 shows a schematic arrangement of an exposure apparatus 1 which is in-line connected to a coating/development apparatus 100 (hereinafter referred to as “Co/Dev 100”) via a wafer transport passage 120. With Co/Dev 100, the wafer before the exposure is coated with a resist, and the exposed wafer is subjected to a development process. The exposure apparatus 1 and Co/Dev 100 are generically managed by a superordinate CPU 110. The embodiment of the present invention will be described assuming that the exposure apparatus 1 and Co/Dev 100 are subjected to the in-line connection. However, it goes without saying that the present invention is also applicable to an exposure apparatus which is not subjected to the in-line connection as described above. When the exposure apparatus is not in-line connected, an operator transports the wafer by hand on the way corresponding to the portion of the wafer transport passage 120 (for the delivery of the wafer between the exposure apparatus 1 and Co/Dev 100).

In the exposure apparatus 1, the illumination light beam (exposure light beam), which is emitted from a light source 2 such as a super high voltage mercury lamp and an excimer laser, is reflected by a reflecting mirror 3, and it comes into a wavelength selection filter 4 through which only a light beam having a wavelength necessary for the exposure is transmitted. The illumination light beam, which has transmitted through the wavelength selection filter 4, is adjusted into a light flux having a uniform intensity distribution by an optical integrator (fly's eye lens or rod) 5, and it arrives at a reticle blind (field diaphragm) 6. The reticle blind 6 has a plurality of blades which are driven by a driving system 6a to determine the aperture S so that the size of the aperture S is changed to set an illumination area on the reticle (mask) R as a first object.

The illumination light beam, which has passed through the aperture S of the reticle blind 6, is reflected by a reflecting mirror 7, and it comes into a lens system 8. The image of the aperture S of the reticle blind 6 is focused by the lens system 8 onto the reticle R which is held on a reticle stage 20. Thus, a desired area on the reticle R is illuminated therewith. In FIG. 1, an illumination optical system is constructed by the wavelength selection filter 4, an optical integrator 5, the reticle blind 6, and the lens system 8.

The reticle stage 20 is moved by a drive unit 17 such as a linear motor in the X direction and the Y direction which are orthogonal with each other and which are perpendicular to the optical axis direction (Z direction) of a projection optical system 9 and in the direction of rotation about the Z axis. Further, the position and the angle of rotation of the reticle stage 20 (and consequently those of the reticle R) are detected by unillustrated laser interferometers. Measured values obtained by the laser interferometers are outputted to a stage control system 14, a main control system 15, and an alignment control system 19 respectively as described later on. During the scanning exposure, the reticle stage 20 is scanned by the drive unit in the Y direction (direction perpendicular to the plane of paper in FIG. 1) in synchronization with a wafer stage 10 (details will be described later on).

A first reference member 24 is provided on the reticle stage 20. A reticle fiducial mark RFM, which is composed of line and space, is formed of a highly reflective material such as Cr on a reference plane 24a which is the lower surface of the first reference member 24 (details will be described later on). The first reference member 24 is installed on approximately the same plane as the plane on which the reticle R is held on the reticle stage 20. Therefore, a reference plane Ra of the reticle R, on which a reticle alignment mark RM is formed, is positioned on approximately the same plane as the reference plane 24a of the first reference member 24.

An image of a pattern (device pattern) PT existing in the illumination area of the reticle R and/or an image of a wafer alignment mark to be transferred onto the wafer W are/is formed by the projection optical system (first optical system) 9 onto the wafer (substrate) W applied with the resist. Accordingly, a specified area (shot area) on the wafer W placed on the wafer stage (substrate stage) 10 is exposed with the image of the pattern PT on the reticle R and/or the image of the alignment mark. The mark formed on the reticle R will be described later on.

The image of the pattern PT and/or the image of the alignment mark are/is projected onto the wafer W, for example, at a reduction magnification of ¼ by a plurality of lens elements which are constructed in group and which are arranged in a lens barrel of the projection optical system 9 while being separated from each other by predetermined spacing distances in the optical axis direction. A variety of image formation characteristics of the projection optical system 9 can be adjusted by moving the lens elements in the optical axis direction by driving a plurality of expandable/contractible driving elements arranged in the circumferential direction. For example, when the lens elements are moved in the optical axis direction, it is possible to change the magnification by using the optical axis as the center. When the lens elements are inclined about the center of the axis intersecting perpendicularly to the optical axis, it is possible to change the distortion. The image formation characteristics of the projection optical system can be also adjusted by controlling the gas pressure in the tightly closed space provided between the lens elements, not by moving the lens elements. The image formation characteristics of the projection optical system 9 are adjusted by an image formation characteristic-adjusting unit 22 which is generically controlled by the main control system 15.

The wafer stage 10 has a wafer holder (not shown) which vacuum-attracts the wafer W. Further, the wafer stage 10 is movable in a non-contact manner over a surface plate 23 in the X direction and the Y direction which are orthogonal with each other and which are perpendicular to the optical axis direction (Z direction) of the projection optical system 9 by the aid of a drive unit 11 such as a linear motor. Accordingly, the wafer W is moved two-dimensionally on the image plane side with respect to the projection optical system 9. The image of the pattern on the reticle R is transferred to the respective shot areas on the wafer W, for example, in accordance with the step-and-scan system. The wafer stage 10 is constructed such that the position of the wafer W in the optical axis direction is adjusted by moving the wafer holder in the Z direction. The wafer holder is moved in the Z direction by the drive unit 11 as well. During the scanning exposure, the wafer stage 10 is subjected to the scanning by the drive unit 11 in the Y direction (direction perpendicular to the plane of paper in FIG. 1) in synchronization with the reticle stage 20 (in the direction opposite to the reticle stage 20) at a velocity corresponding to the reduction magnification of the projection optical system 9 (¼ of the scanning velocity of the reticle stage 20, for example, when the reduction magnification is ¼).

The positions in the X direction and the Y direction and the amount of rotation (yawing amount, pitching amount, and rolling amount) of the wafer stage 10 (and consequently those of the wafer W) on the wafer stage coordinate system (orthogonal coordinate system) XY are detected by a laser interferometer 13 which radiates a laser beam onto a movement mirror (reflecting mirror) 12 provided at the end of the wafer stage 10. Measured values (position information) obtained by the laser interferometer 13 are outputted to the stage control system 14, the main control system 15, and the alignment control system 19 respectively.

The surface plate 23 is formed of a stone material having sufficient rigidity such as Indian Black in which the coefficient of thermal expansion is approximately the same as those of iron steel materials. The surface of the surface plate 23 is coated with ceramics, for example, by means of the molten deposition. Those applicable as the ceramics include, for example, ceramics based on alumina (for example, gray alumina and alumina titania) as well as silicon nitride, tungsten carbide, titania, and chromium oxide (chromia). Further, the surface plate 23 may be constructed by effecting the molten deposition of ceramics on an iron steel material.

An autofocus system 30 of the oblique incidence type, which has a light-feeding system 30a and a light-receiving system 30b to measure the position of the wafer W in the optical axis direction on the XY plane (two-dimensional plane), is arranged over the wafer stage 10. The light-feeding system 30 radiates detecting light beams onto a plurality of measuring points on the wafer W. For example, 49 spots, which are arranged in a lattice-shaped form of 7×7 while being separated from each other by spacing distances, are set as the measuring points. The light-receiving system 30b receives the detecting light beams reflected by the respective measuring points. Received signals are outputted to the main control system 15 via the stage control system 14. The main control system 15 moves the wafer stage 10 (wafer holder) in the Z direction on the basis of the outputted signals by the aid of the stage control system 14 and the drive unit 11. Accordingly, the wafer W is positioned at the focus positions of the projection optical system 9 and the alignment sensor 16 (as described later on). The stage control system 14 controls the movement of the reticle stage 20 and the wafer stage 10 respectively, for example, by the aid of the drive units 11, 17 on the basis of the position information outputted, for example, from the main control system 15 and the laser interferometer 13.

An explanation will now be made of the reticle alignment mark RM, the wafer alignment mark AM, the fiducial mark (wafer fiducial mark) FM, and the reticle fiducial mark RFM of the embodiment of the present invention.

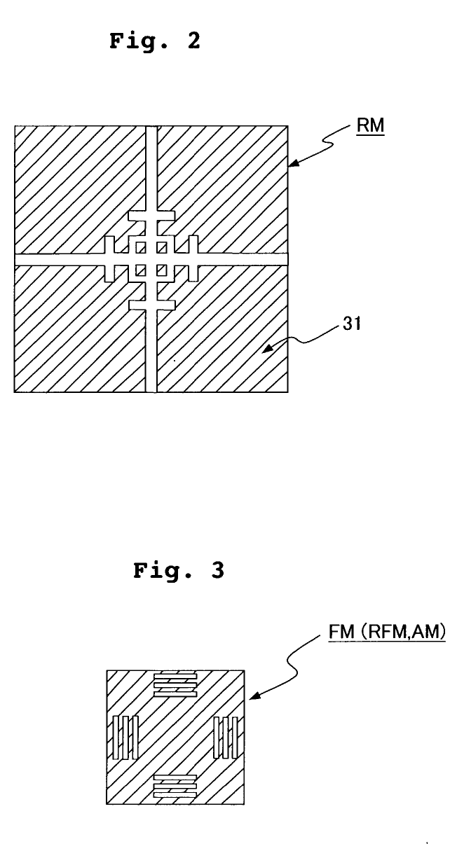

The reticle R has the reticle alignment mark RM which is formed on the circumferential area of the pattern area in which the circuit pattern PT and/or the wafer alignment mark AM are/is formed. The reticle alignment mark RM is used when the reticle R is positionally adjusted with respect to the wafer stage coordinate system. The reticle alignment mark RM is provided as a pair of two at positions which are symmetrical in relation to the Y axis passing through the center of the reticle R. As shown in FIG. 2, the reticle alignment mark RM is composed of a cross mark which divides the rectangular light-transmitting section 31 into four, a square frame-shaped mark which is formed approximately at the center of the rectangular light-transmitting section 31 to surround the point of intersection of the cross mark, and linear marks which are arranged opposingly to the respective sides of the square frame-shaped mark. No problem arises, for example, even when the circuit pattern PT and the reticle alignment mark RM are any one of the half tone having a low reflectance and Cr having a high reflectance. The reticle alignment marks RM are measured by the alignment sensor 16 as described later on. In this embodiment, the illustrated two-dimensional marks are used as the reticle alignment marks RM. However, there is no limitation to the two-dimensional marks. One-dimensional marks are also available.

The plurality of shot areas, i.e., the plurality of areas to which the image of the circuit pattern PT formed on the reticle R is transferred are set on the wafer W. The wafer alignment mark AM, which is used to measure the position on the wafer, is formed on a predetermined layer (for example, on the first layer) corresponding to each of the shot areas. One having the most appropriate shape is selected for the wafer alignment mark AM depending on the wafer alignment sensor to be used. It is possible to select those having a variety of shapes including, for example, those constructed by the line and space and those having the lattice form. However, in the embodiment of the present invention, the wafer alignment mark AM, which has a shape similar to that of the fiducial mark FM as described later on, is used (see FIG. 3). A search mark for the search alignment is also formed on the wafer W corresponding to each of the shot areas. However, the search mark is omitted from the explanation herein.

A second reference member 18 (see FIG. 1) is fixed on the wafer stage 10. A fiducial mark FM, which is composed of the line and space on a reference plane (predetermined plane on the second object) 18a having the same height as that of the surface of the wafer W (approximately the same plane), is formed on the second reference member 18. An example of the fiducial mark FM is shown in FIG. 3. The fiducial mark FM is formed of a material having a high reflectance such as Cr on a light-transmissive material such as glass. On the other hand, the first reference member 24 is fixed on the reticle stage 20 as described above. The reticle fiducial mark RFM is formed on the reference plane 24a of the first reference member 24 in the same manner as the fiducial mark FM.

With reference to FIG. 1 again, the exposure apparatus 1 is provided with the alignment sensor (second optical system) 16 based on the TTR (through-the-reticle) system for performing the positional adjustment for the reticle R and performing the positional adjustment for the reticle R and the wafer W. The exposure apparatus 1 is also provided with an FIA (Field Image Alignment) alignment system 200 based on the known off-axis system and based on the image processing system. However, the alignment system 200 is omitted from the explanation, because it does not directly relate to the present invention.

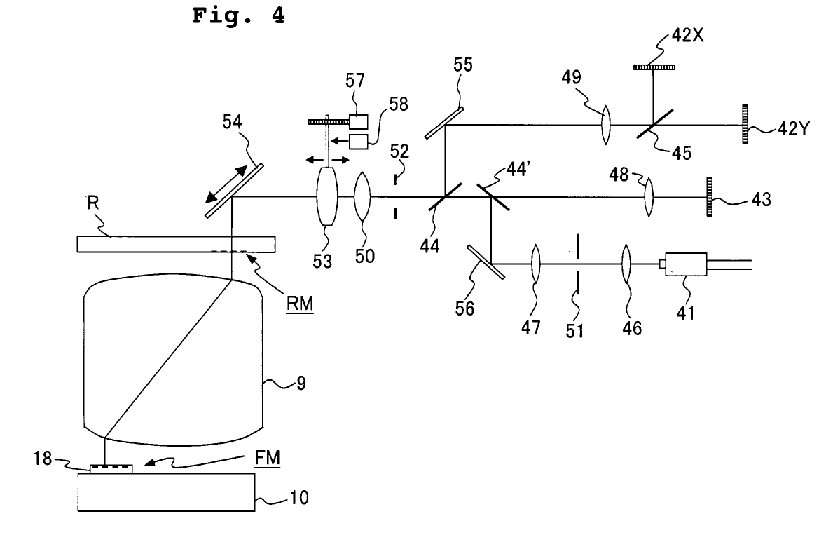

An arrangement of the alignment sensor 16 is shown in FIG. 4. FIG. 4 shows only the alignment sensor 16 disposed on the right side as viewed in the direction toward the exposure apparatus 1. However, actually, another one is arranged at an approximately symmetrical position on the opposite side in the X direction with the optical axis of the projection optical system 9 being interposed therebetween (see FIG. 1). The alignment sensor 16 comprises, for example, an alignment light source 41, image pickup elements 42X, 42Y such as CCD's, an image pickup element 43 for monitoring, beam splitters 44, 44′, 45, optical elements 46 to 50 such as condenser lenses and objective lenses, reflecting mirrors 55, 56, an illumination field diaphragm 51, a diaphragm 52, an internal focusing system lens 53, an internal focusing system lens-driving unit 57, and an internal focusing system lens position-detecting unit 58. An epi-reflection mirror 54, that is driven between an escape position at which the exposure light beam coming into the projection optical system 9 is not disturbed and a measuring position at which the positional adjustment is performed for the reticle R or the wafer W, is installed between the reticle R and each of the alignment sensors 16 constructed by the components as described above.

As for the alignment light source 41, for example, the illumination light beam for the exposure is introduced with a light guide. The alignment light source 41 is constructed to radiate the detecting beam having approximately the same wavelength as that of the illumination light beam for the exposure radiated from the light source 2.

The image pickup element 42X measures the position information about the observed mark in the X direction. The image pickup element 42Y measures the position information about the observed mark in the Y direction. The image pickup signals, which are measured by the image pickup elements 42X, 42Y, are outputted to the alignment control system 19. The monitoring image pickup element 43 observes a wide range as compared with the image pickup elements 42X, 42Y. The monitoring image pickup element 43 outputs the image pickup signal to an unillustrated observing monitor as well as to the alignment control system 19. The image pickup signal of the monitoring image pickup element 43, which is outputted to the alignment control system 19, is used for the search alignment (rough alignment) for the reticle R. The internal focusing system lens 53 is movably driven by the internal focusing system lens-driving unit 57 along the optical path of the detecting beam for the alignment under the control of the alignment control system 19. The internal focusing system lens position-detecting unit 58 detects the position of the internal focusing system lens 53. The detected position information about the internal focusing system lens 53 is outputted to the alignment control system 19.

The detecting beam (illumination beam), which is radiated from the alignment light source 41, passes through the optical elements 46, 47, 50 and the internal focusing system lens 53, and it outgoes from the alignment sensor 16. The detecting beam is reflected by the epi-reflection mirror 54 to illuminate the reticle alignment mark RM on the reticle R with an illumination field determined by the illumination field diaphragm 51. The reflected light beam, which is reflected by the reticle alignment mark RM, passes along the epi-reflection mirror 54, the internal focusing system lens 53, the optical element 50, the beam splitter 44, and the optical element 48, and it comes into the image pickup element 43. Simultaneously, the reflected light beam is reflected by the beam splitter 44, and it comes into the image pickup elements 42X, 42Y via the optical element 49 and the beam splitter 45.

On the other hand, the detecting beam, which is transmitted through the reticle R, illuminates, via the projection optical system 9, the wafer alignment mark on the wafer W or the fiducial mark FM of the second reference member 18 fixed on the wafer stage 10. The reflected light beam, which is reflected by the wafer alignment mark AM or the fiducial mark FM, is transmitted through the projection optical system 9 and the reticle R, and then it comes into the image pickup elements 42X, 42Y, 43 along with the same optical paths as those of the case of the reflection by the reticle alignment mark RM.

In the alignment sensor 16, the image of the fiducial mark FM coming thereinto via the projection optical system 9 and the image of the reticle alignment mark RM on the reticle R are simultaneously photographed by the image pickup elements 42X, 42Y in each of the X direction and the Y direction. The obtained image pickup signals are outputted to the alignment control system 19. The alignment control system 19 detects the positional deviation amounts of the both marks for each of the directions on the basis of the inputted image pickup signals. The measured values obtained by laser interferometer 13 or the like for detecting the positions of the reticle stage 20 and the wafer stage 10 respectively and the information stored in the storage unit 21 are also inputted into the alignment control system 19 so that the positional deviation amounts are corrected to determine the respective positions of the reticle stage 20 and the wafer stage 10 at which the corrected positional deviation amounts of the both marks are predetermined values, for example, zero. Accordingly, the position of the reticle R on the wafer stage coordinate system XY is detected. In other words, the reticle stage coordinate system and the wafer stage coordinate system XY are correlated with each other (i.e., detection of the relative positional relationship). The alignment control system 19 outputs the obtained result (position information) to the main control system 15.

The main control system 15 controls the size and the shape of the aperture S of the reticle blind 6 by the aid of the driving system 6a. Further, the main control system 15 calculates the shot arrangement error parameter as the position information to represent the arrangement characteristics of all of the shot areas in accordance with the statistical calculation technique on the basis of the position information (coordinate values) about the alignment marks in a part of the shot areas (sample shot areas) on the wafer W outputted from the alignment control system 19 (this positioning system is called “enhanced global alignment” (hereinafter referred to as “EGA”), the sample shot area is referred to as “EGA shot”, and the shot arrangement error parameter is referred to as “EGA parameter”). Based on the calculation result, the main control system 15 corrects the projection magnification of the projection optical system 9, if necessary, or it corrects the synchronous scanning velocity ratio between the wafer stage 10 and the reticle stage 20. Further, the main control system 15 outputs the position information about all of the shot areas calculated with the EGA parameter to the stage control system 14. The stage control system 14 controls the movement of the wafer stage 10 and the reticle stage 20 (including the synchronous movement of the both stages during the exposure) respectively by the aid of the drive units 11, 17 on the basis of the position information supplied from the main control system 15. Accordingly, for example, the image of the pattern on the reticle R is transferred to the respective shot areas on the wafer W, for example, in accordance with the step-and-scan system.

The storage unit 21, which stores the exposure data (recipe) including, for example, the exposure order and the arrangement position of the shot area, is juxtaposed with the main control system 15. The main control system 15 generically controls the entire apparatus on the basis of the exposure data. The focusing position data of the alignment sensor 16, which is detected by the internal focusing system lens position-detecting unit 58, is stored in the storage unit 21 together with the exposure data.

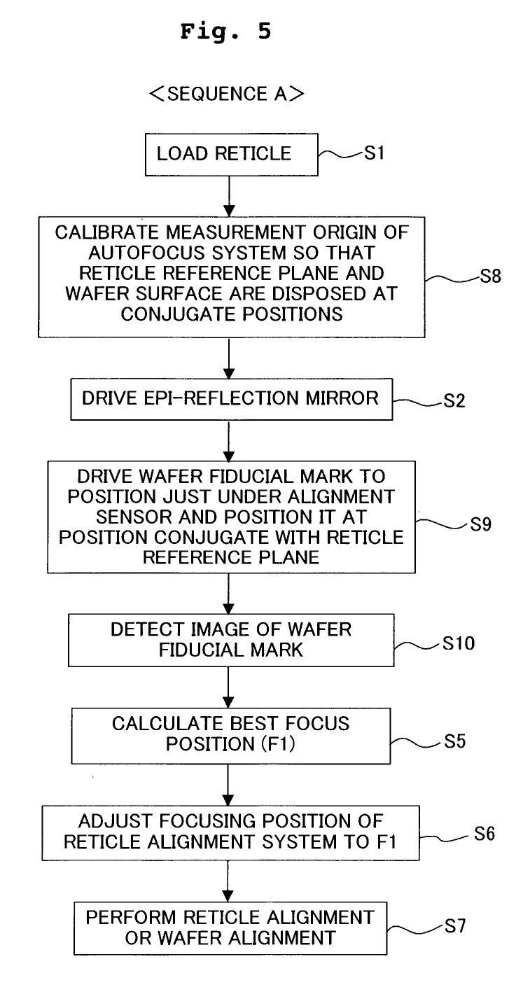

Sequences for carrying out the focus adjustment for the alignment sensor 16 included in the exposure apparatus 1 constructed as described above will be firstly explained with reference to flow charts shown in FIGS. 5 and 9 to 11. An explanation will be made now about the sequences of three modes, i.e., Sequences A, B, and C respectively.

### Sequence A

In this mode, the focus adjustment is carried out for the alignment sensor 16 by observing the fiducial mark FM at all times.

That is, as shown in FIG. 5, when the reticle R is loaded on the reticle stage 20 at the beginning of a lot (Step S1), the position of the image plane is measured for the projected image of the circuit pattern PT of the reticle R projected by the projection optical system 9 by means of a technique such as the aerial image measurement (AIS) so that the reference plane Ra of the reticle R and the reference plane 18a of the second reference member 18 are disposed at optically conjugate positions with respect to the projection optical system 9. The measurement origin of the autofocus system 30 is calibrated (focus calibration) by using the obtained measurement result (Step S8). Accordingly, a predetermined plane on the wafer stage 10 (for example, the surface of the wafer W or the reference plane 18a of the second reference member 18) can be positioned at the position which is optically conjugate with the reference plane Ra of the reticle R by using the autofocus system 30 in Step S8 and the steps to be performed thereafter.

For example, when the aerial image is measured, the exposure light beam is radiated while relatively moving the slit mark provided on the reticle R and the slit mark provided on the wafer stage 10 to measure the illuminance of the exposure light beam transmitted through the both slit marks. This operation is successively repeated while changing the position of the wafer stage 10 in the Z direction. Signal intensities obtained thereby are processed with a predetermined algorithm to determine the relative relationship between the position of the wafer stage 10 and the contrast. A midpoint at an appropriate slice level is determined from a signal waveform of the determined relative relationship. Accordingly, it is possible to determine the position at which the reference plane Ra of the reticle R and the reference plane 18a of the second reference member 18 are optically conjugate with each other with respect to the projection optical system 9. As described above, when the position is used as the measurement origin of the autofocus system 30, the surface of the wafer W on the wafer stage 10 and the reference plane 18a of the second reference member 18 can be positioned at the positions conjugate with the reticle pattern plane.

Subsequently, the epi-reflection mirror 54 is driven from the escape position to the measuring position (Step S2). The wafer stage 10 is driven so that the fiducial mark (wafer fiducial mark) FM of the second reference member 18 is located at the position just under the alignment sensor 16. Further, the autofocus system 30 is used to perform the positioning so that the reference plane 18a of the second reference member 18 is disposed at the position which is optically conjugate with the reticle pattern plane Ra (Step S9). In this situation, the reticle R is positioned so that the reticle alignment mark RM is positioned at the light-transmitting section 31 at which no interference occurs with respect to the fiducial mark FM (see FIG. 2).

Subsequently, the image of the fiducial mark FM of the reference member 18 is detected by the image pickup element 42X while moving the internal focusing system lens 53 along the optical path of the detecting beam (Step S10). The change of the signal waveform is processed with an appropriate algorithm such as a differential process to thereby calculate the position at which the focusing position of the alignment sensor 16 is coincident with the fiducial mark FM on the second reference member 18, i.e., the so-called best focus position F1 (Step S5).

This process will be described in detail below.

At first, the alignment control system 19 positions the position of the internal focusing system lens 53 at a predetermined measurement start position Fs. The measurement start position Fs may be set at any one of ends of the movable range of the internal focusing system lens 53. However, when the best focus position F1 has been already roughly known, for example, when the best focus position has been recorded for each reticle R, and the value thereof is available, for example, from the identification number of the reticle R, then the measurement start position Fs may be set in the vicinity of the best focus position F1. Accordingly, it is possible to shorten the time required to measure the best focus position.

After the internal focusing system lens 53 is positioned at the measurement start position Fs, the image of the fiducial mark FM is detected by the image pickup element 42X. The measurement start position Fs and the image pickup signal, which are correlated with each other, are outputted from the alignment control system 19 to the main control unit 15, and they are stored in the storage unit 21. This operation is repeated until arrival at the measurement end position Fe while moving the internal focusing system lens position at constant pitches. The measurement end position Fe can be also set in the vicinity of the predicted best focus position in the same manner as the measurement start position Fs. The time required to measure the best focus position can be further shortened by shortening the spacing distance between the measurement start position Fs and the measurement end position Fe.

The image pickup signals, which are detected at the respective internal focusing system lens positions, are processed in accordance with a certain algorithm to calculate the contrasts C at the respective internal focusing system lens positions. One focus signal waveform is determined for a series of the measurement operation according to the contrasts C at the respective internal focusing system lens positions ranging from the measurement start position Fs to the measurement end position Fe.

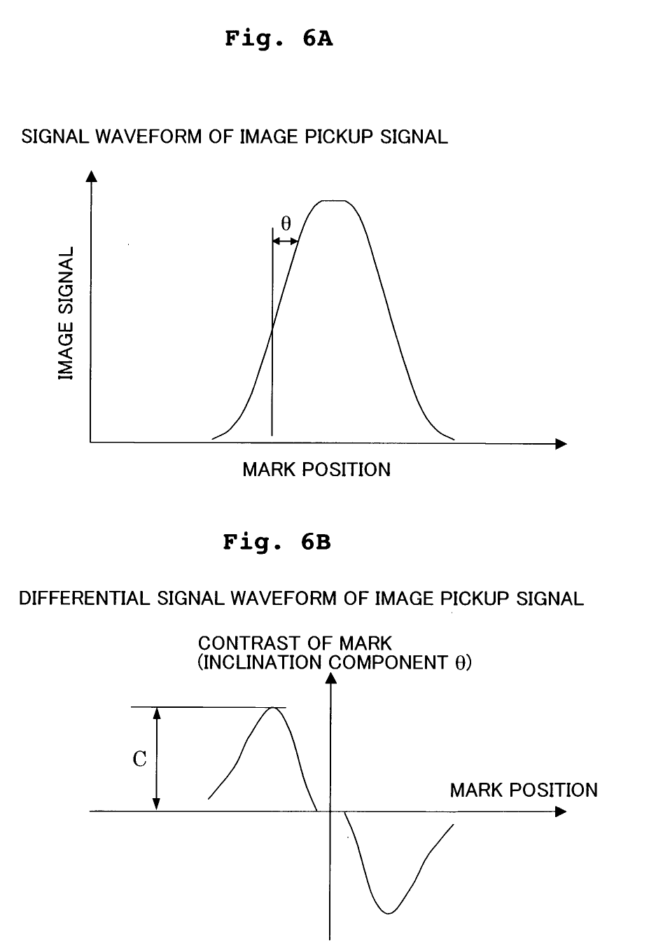

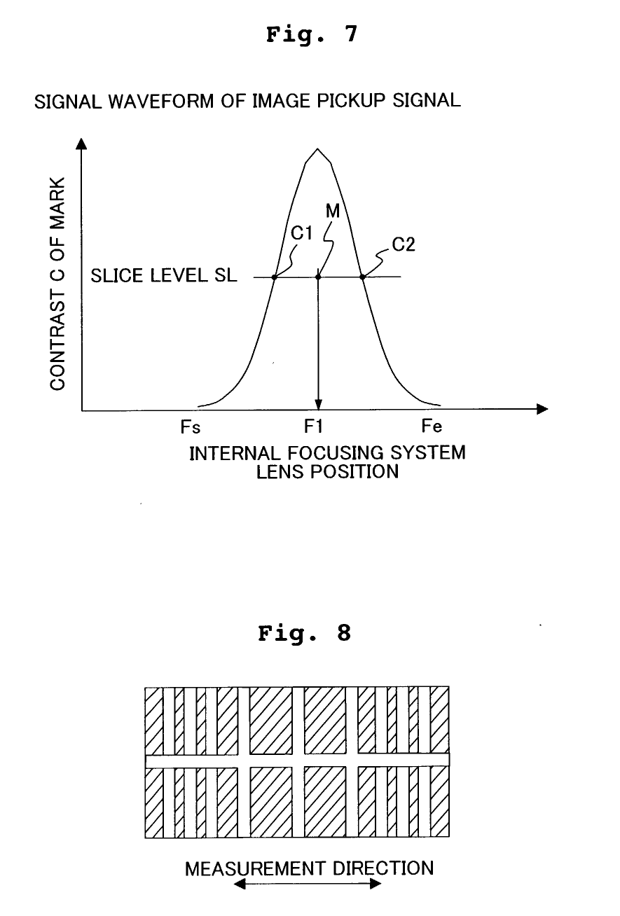

An example of the process to determine the focus signal waveform from the image pickup signal will be explained with reference to FIGS. 6 and 7.

FIG. 6A depicts the image pickup signal waveform of a single mark while the vertical axis represents the image pickup signal and the horizontal axis represents the coordinate position of the mark. FIG. 6B shows the signal waveform obtained by differentiating and processing the image pickup signal shown in FIG. 6A. In the embodiment of the present invention, the maximum inclination component θ of the image pickup signal waveform (see FIG. 6A) is designated as the contrast. The contrast is obtained by applying the differential processing to the image pickup signal waveform and calculating the maximum value of the differential signal waveform obtained thereby (see FIG. 6B). The focus signal waveform (see FIG. 7) can be determined from the correlative relationship between the maximum contrast C (i.e., the maximum inclination component θ) determined from the differential signal waveform and the position of the internal focusing system lens 53 correlated with the image signal (see FIG. 7). Other than the above, a method, in which the peak-to-peak value of the signal is used, is also available to determine the contrast C. Any method may be adopted to determine the contrast C.

Next, an explanation will be made of the algorithm to calculate the best focus position F1 from the focus signal waveform with reference to FIG. 7 which shows the focus signal waveform.

FIG. 7 shows the contrast of the image pickup signal on the vertical axis and the position of the internal focusing system lens 53 on the horizontal axis. The following method is generally used as the algorithm to calculate the best focus position F1. That is, the focus signal waveform is sliced at a certain slice level SL (for example, 50%), and the position, which corresponds to the midpoint M between two points of intersection C1, C2 between the focus signal waveform and the slice level, is regarded as the best focus position F1. Other than the above, a variety of methods may be conceived as for the algorithm to calculate the best focus position, including, for example, one in which the point of the maximum contrast C is regarded as the best focus position, and one in which the midpoints are calculated with a plurality of slice levels to obtain an average thereof. Therefore, no problem of course arises even when the best focus position F1 is determined in accordance with another algorithm. The foregoing explanation has been made about the image pickup signal of the single mark for the purpose of simplification. However, it goes without saying that the same or equivalent processing can be performed for a plurality of marks.

In the embodiment of the present invention, the image pickup signal is incorporated by stepping the internal focusing system lens 53. Alternatively, the internal focusing system lens 53 may be moved continuously, during which the image pickup signal and the position of the internal focusing system lens 53 may be simultaneously incorporated at a constant sampling frequency. Accordingly, it is possible to shorten the time required to detect the best focus position by continuously obtaining the image pickup signal.

In the embodiment of the present invention, the example, in which only the image pickup signal of the image pickup element 42X is used, has been explained. However, the image pickup signal of the image pickup element 42Y may be used. Alternatively, an average value of the respective best focus positions determined by the both may be used as the best focus position of the alignment sensor 16.

According to the method as described above, it is possible to determine the best focus position F1 of the internal focusing system lens 53 in order to adjust the focusing position of the alignment sensor 16 to the fiducial mark FM (reference plane 18a).

In Step S6, the alignment control system 19 controls the internal focusing system lens-driving unit 57 so that the internal focusing system lens 53 has the best focus position F1. When the focus adjustment for the alignment sensor 16 is completed as described above, the reticle alignment or the wafer alignment is carried out in Step S7. In the foregoing description, the sequence, which is adopted in the case of the beginning of the lot, has been described. In the case of the middle of the lot, a part of the sequence corresponding to Step S2 to Step S6 shown in FIG. 5 may be carried out. Further, Step S8 may be added just before Step S2, if necessary. When this sequence is executed during the interval baseline check in the middle of the lot, the movable range of the internal focusing system lens 53 in Step S10, i.e., the range to measure the best focus (Fs-Fe) can be set in a narrow range in the vicinity of the previous best focus position, because the best focus position F1 is not changed greatly. Accordingly, it is possible to shorten the time required to measure the best focus.

### Sequence B

In this mode, the mark to be observed is distinguished between the case of the beginning of the lot and the case of the middle of the lot to carry out the focus adjustment for the alignment sensor 16.

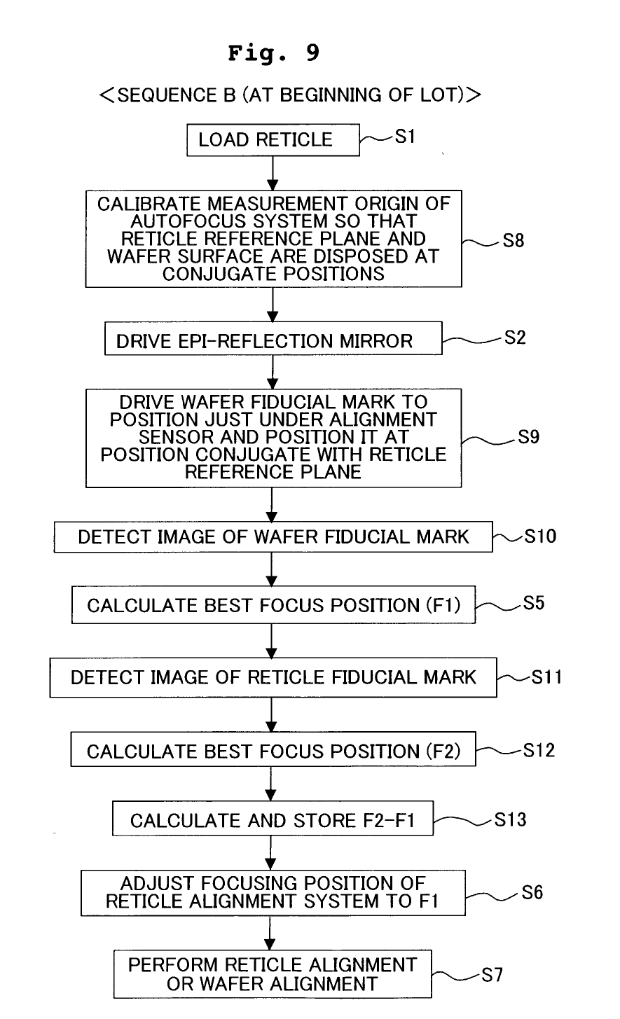

That is, at the beginning of the lot, as shown in FIG. 9, the reticle R is loaded on the reticle stage 20 (Step S1), and then the best focus position F1 is calculated in accordance with the same procedure as that used in Sequence A. The best focus position F1 is stored as the first focusing position data in the storage unit 21 (Step S8 to Step S5).

Subsequently, the reticle stage 20 is driven so that the reticle fiducial mark RFM of the first reference member 24 is positioned just under the alignment sensor 16. During this process, the driving operation is performed for the wafer stage 10 so that the underlying base, which is disposed just under the alignment sensor 16, does not have a high reflectance, for example, the surface plate 23 is exposed at the position just under the alignment sensor 16. The image of the reticle fiducial mark RFM is detected by the image pickup element 42X while moving the internal focusing system lens 53 along the optical path of the detecting beam (Step S11). The detected image pickup signal is processed by an appropriate algorithm such as a differential process, and the signal is correlated with the position of the internal focusing system lens 53 at which the image pickup signal is detected. Accordingly, the best focus position F2, at which the focusing position of the alignment sensor 16 is coincident with the reticle fiducial mark RFM, is calculated (Step S12) in the same manner as in the observation of the fiducial mark FM. The best focus position F2 is stored as the second focusing position data in the storage unit 21.

When the best focus position F1 is calculated with the fiducial mark FM, and the best focus position F2 is calculated with the reticle fiducial mark RFM, then the difference F2−F1 between the positions F2 and F1 is calculated in Step S13, and it is stored in the storage unit 21. After that, when the internal focusing system lens 53 is driven by the alignment control system 19 so that the best focus position F1 is obtained in Step S6 in the same manner as in Sequence A, and thus the focus adjustment for the alignment sensor 16 is completed, then the reticle alignment is carried out in Step S7.

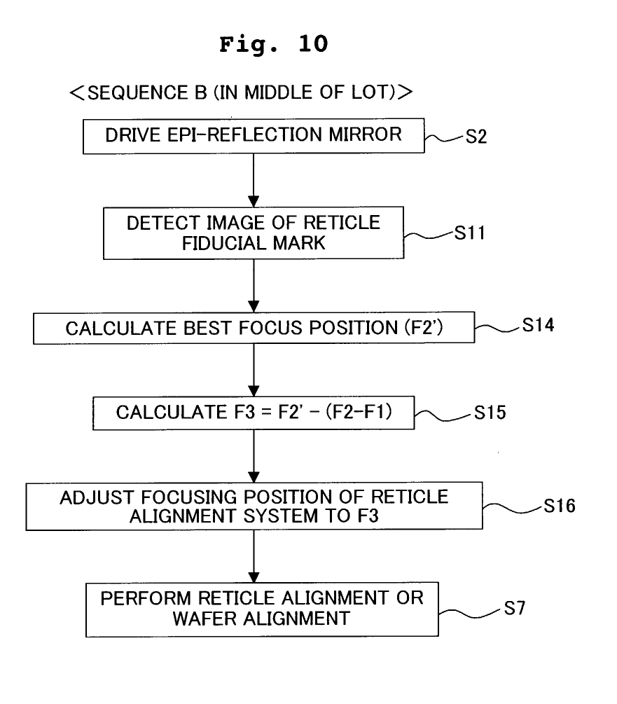

Subsequently, when the interval baseline check is carried out in the middle of the lot, or when the EGA measurement is performed for each wafer, then the epi-reflection mirror 54, which has been retracted during the exposure, is driven from the escape position to the measuring position as shown in FIG. 10 (Step S2). The image of RFM is detected by the image pickup element 42X (Step S11) while moving the internal focusing system lens 53 along the optical path of the detecting beam in the same manner as described above to calculate the best focus position F2′ at which the focusing position of the alignment sensor 16 is coincident with the reticle fiducial mark RFM (Step S14). During this process, the wafer stage 10 is moved to the waiting position for the wafer exchange. Therefore, the underlying base during the measurement of the reticle fiducial mark RFM with the alignment sensor 16 is constructed by the surface plate 23 having the low reflectance.

The main control system 15 calculates the new best focus position F3 in accordance with the following expression by using the positions F1, F2 stored in the storage unit 21 and the calculated position F2′ (Step S15).

F3=F2′−(F2−F1) (1)

When the measurement with the alignment sensor 16 is reproducible, the position F2 is coincident with the position F2′. However, the position F2′ is not necessarily coincident with the position F2 due to the disturbance including, for example, the mechanical error brought about by the driving of the epi-reflection mirror 54 as described above and the dispersion of the thickness of the reticle R. Therefore, any harmful influence, which would be otherwise caused by the disturbance, can be excluded by correcting the position F2′ with the difference between the positions F1 and F2 measured when the alignment sensor 16 is subjected to the focus adjustment.

After that, the internal focusing system lens 53 is driven by the alignment control system 19 so that the best focus position F3 is obtained (Step S16). When the focus adjustment for the alignment sensor 16 is completed, the reticle alignment or the wafer alignment is carried out in Step S7.

Step S8 described above can be added just before Step S2, if necessary, in the same manner as in Sequence A.

### Sequence C

In this mode, Sequence A and Sequence B described above are selectable on the basis of a preset exposure recipe. That is, in the case of Sequence A, it is enough to perform the mark measurement once. However, it is necessary for the wafer stage 10 to stay at the predetermined position during the mark measurement. On the other hand, in the case of Sequence B, the operation such as the wafer exchange can be carried out by driving the wafer stage 10 during the mark measurement in the middle of the lot. However, it is necessary to perform the mark measurement twice for the fiducial mark FM and the reticle fiducial mark RFM at the beginning of the lot, in which the throughput is lowered depending on the circumstances. Accordingly, in this mode, the throughput, which may be obtained when any one of the sequences is executed, is calculated to select the sequence to be executed.

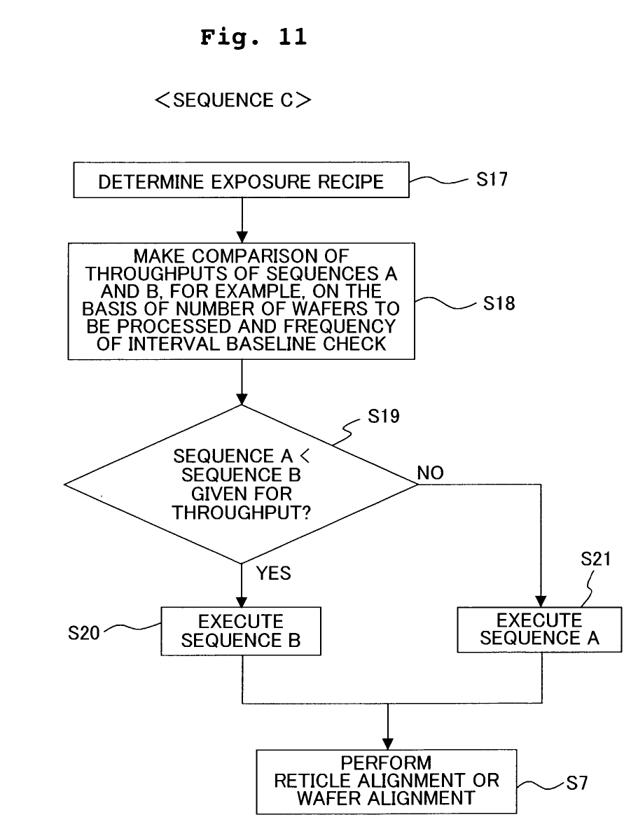

This procedure will be explained in detail below. As shown in FIG. 11, when the exposure recipe is determined and it is stored in the storage unit 21 (Step S17), then the main control system 15 calculates the throughput to be obtained when each of the sequences is executed, for example, on the basis of the number of wafers to be processed and the frequency of the interval baseline check (Step S18). The throughputs of the respective sequences are compared with each other (Step S19), and the sequence, which is more excellent in throughput, is executed (Step S20 or S21). After that, when the focus adjustment for the alignment sensor 16 is completed, the reticle alignment or the wafer alignment is carried out in Step S7.

The focus adjustment for the alignment sensor 16 is completed by executing any one of Sequences A to C as described above.

Next, an explanation will be made about a procedure to carry out the exposure process by using the alignment sensor 16 to which the focus adjustment has been applied as described above.

In the reticle alignment to be performed after carrying out the focus adjustment for the alignment sensor 16, the position of the reticle R on the reticle stage 20 with respect to the optical axis of the projection optical system 9 is measured on the basis of the wafer stage coordinate system in the exposure apparatus 1 to effect the positional adjustment (alignment). The reticle alignment may be carried out at any timing provided that the timing is included in a range from the exchange of the reticle to the start of the exposure. In the reticle alignment, the reticle R corresponds to the first object, and the second reference member 18 corresponds to the second object.

The reticle alignment will be described in detail below. A pair of reticle alignment marks RM are moved to the detection areas (measurement positions) of the alignment sensors 16 by driving the drive unit 17 by the stage control system 14. The fiducial mark FM of the second reference member 18 on the wafer stage 10 is moved to the detection area by driving the drive unit 11. As described above, the alignment sensor 16 simultaneously photographs the image of the reticle alignment mark RM illuminated with the detecting beam and the image of the fiducial mark FM coming thereinto via the projection optical system 9, and the obtained result is outputted to the alignment control system 19. FIG. 8 shows an example of the image pickup signal of the mark image in which the fiducial mark FM and the reticle alignment mark RM are combined and simultaneously measured. The alignment control system 19 performs the process such as one-dimensional compression for the outputted image pickup signal to measure the positional deviation amount between the reticle alignment mark RM and the fiducial mark FM. The measurement result is outputted to the main control system 15.

In the case of the exposure apparatus based on the full field exposure system (stepper), when the pair of reticle alignment marks RM on the reticle R are measured, the position of the reticle R with respect to the wafer stage coordinate system is decided. However, in the case of the exposure apparatus based on the step-and-scan system (scanner), a plurality of sets of fiducial marks FM arranged in the scanning direction (Y direction) on the second reference member 18, and a plurality of sets of reticle alignment marks RM provided at positions corresponding to the plurality of sets of fiducial marks FM are measured while being correlated with each other in some cases, in order to correct the scanning directions of the wafer stage 10 and the reticle stage 20 and the scanning velocity ratio therebetween. In such a case, the measurement is successively performed a number of times corresponding to the number of the sets of marks in the same manner as described above while moving the wafer stage 10 and the reticle stage 20 in the Y direction.

When the measurement of the reticle alignment marks RM is completed, the main control system 15 performs a predetermined algorithm process on the basis of the designed coordinate values of the respective marks and the measured positional deviation amounts to calculate correction parameters such as those for the XY shift and the rotation. When the stage control system 14 is controlled on the basis of the parameters, then the reticle stage 20 is driven in predetermined amounts in the X direction, the Y direction, and the θZ direction, and thus the reticle R is positioned.

The wafer W, which is transported from Co/Dev 100 onto the wafer stage 10 of the exposure apparatus 1, is irradiated with the detecting beam radiated onto 49 spots of the measuring points from the light-feeding system 30a of the autofocus system 30. The detecting beam, which is reflected by each of the measuring points, is received by the light-receiving system 30b. Right-receiving signals corresponding to the respective measuring points are outputted to the main control system 15. In the main control system 15, the position of the wafer W in the Z direction is determined from the measurement results at the respective measuring points. The main control system 15 selects the measuring point disposed nearest to the wafer alignment mark AM to serve as the measurement objective, from the plurality of measuring points. The main control system 15 uses the measurement result of the selected measuring point to drive the drive unit 11 by the aid of the stage control system 14 so that the measuring point is arranged at the focusing position of the alignment sensor 16 and the projection optical system 9. Accordingly, the wafer W is positionally adjusted in the Z direction so that the wafer alignment mark to serve as the measurement objective is disposed at the focusing position.

In the case of the beginning of the lot for which Sequence B is carried out as described above, the transport and the exchange of the wafer are performed after the completion of the focus adjustment, because the focus adjustment for the alignment sensor 16 is carried out by using the second reference member 18 of the wafer stage 10. However, in the case of the middle of the lot, the wafer exchange can be carried out simultaneously with the focus adjustment, because the focus adjustment is carried out by using the first reference member 24. Therefore, it is possible to contribute to the improvement in throughput.

The search alignment is carried out for the wafer W after the focus adjustment is completed. The wafer W, which is loaded on the wafer stage 10, is placed in a state of being subjected to the prealignment. However, the wafer W is not positioned at such a level that the EGA measurement can be executed as the fine alignment. Therefore, the so-called search alignment, in which the wafer W is roughly adjusted to such an extent that no trouble occurs in the EGA measurement, is usually performed before executing the EGA measurement. In the search alignment, the search alignment mark is measured in previously designated shot areas (for example, two places), and the designed coordinate value of the wafer alignment mark is corrected on the wafer stage coordinate system XY for each of the EGA shots on the basis of the obtained measurement result.

Subsequently, the stage control system 14 moves the wafer stage 10 on the basis of the measured value of the laser interferometer 13 while using the corrected coordinate value as the target value to position the wafer alignment mark AM in each detection area of the alignment sensor 16 for each EGA shot. Further, the reticle stage 20 is moved to position the reticle alignment mark RM and the wafer alignment mark AM in the detection area. After that, the both marks are photographed by the alignment sensor 16 in a state in which the both marks are superimposed in an identical field to measure the positional deviation amount between the marks in the XY plane by using the alignment control system 19.

When the wafer W is processed in the middle of the lot, the focus adjustment is performed for the alignment sensor 16 before performing the EGA measurement for each wafer W. In this process, the best focus position F1 is calculated by using the fiducial mark FM on the second reference member 18 in Sequence A, while the best focus position F3 is calculated by using the reticle fiducial mark RFM in Sequence B. In Sequence A, no problem arises even when the alignment mark AM on the wafer W is used in place of the fiducial mark FM.

The positional deviation amount of the wafer alignment mark AM is successively measured for each EGA shot in accordance with the same procedure as that described above. After that, the EGA calculation is performed on the basis of the obtained measured value and the designed value to calculate the six EGA parameters, i.e., the X shift, the Y shift, the X scale, the Y scale, the rotation, and the orthogonality as the position information concerning the arrangement characteristics of the shot areas on the wafer W. The designed coordinate positions are corrected for all of the shot areas on the wafer W on the basis of the EGA parameters. Further, the image formation characteristics of the projection optical system 9 are adjusted especially on the basis of the scaling parameters (X scale and Y scale). Accordingly, the wafer W is positioned with respect to the reticle R.

The exposure process is carried out such that the wafer W is successively positioned at the exposure position in accordance with the position information (coordinate value) of each shot on the wafer calculated on the basis of the EGA parameters and the designed coordinate value of each shot as described above, and the circuit pattern, which is formed on the reticle R, is successively transferred onto each of the positioned shot areas (to be exposed therewith).

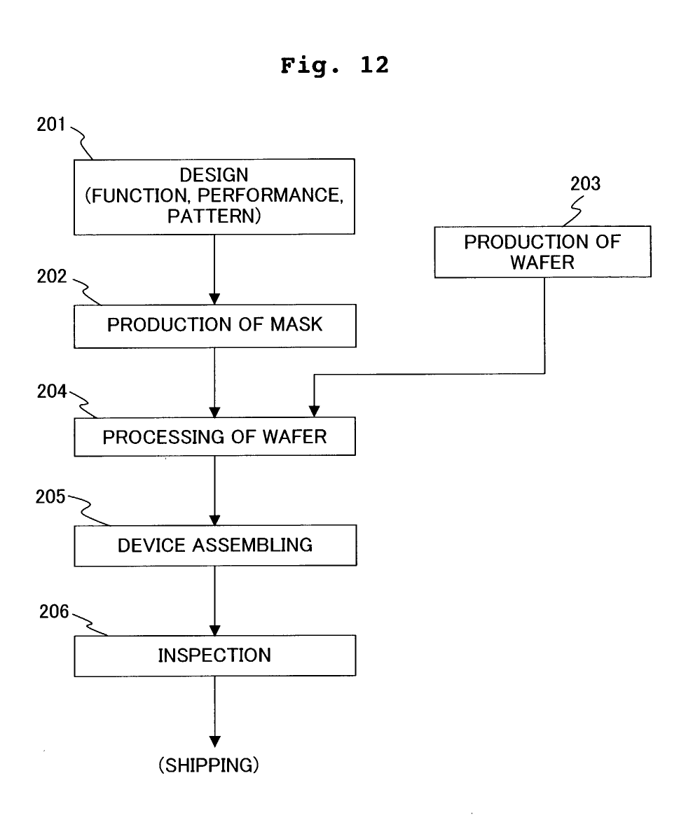

The device such as a semiconductor device is produced by using the wafer W on which the circuit pattern PT is formed. As shown in FIG. 12, the device is produced by performing, for example, a step 201 of designing the function and the performance of the microdevice, a step 202 of manufacturing the reticle R on the basis of the designing step, a step 203 of producing the wafer W of a silicon material, an exposure process step 204 of projecting a pattern on the reticle R onto the wafer W to be exposed therewith by using the projection exposure apparatus 1 according to the embodiment as described above and developing the wafer W, a device-assembling step (including a dicing step, a bonding step, and a packaging step) 205, and an inspection step 206.

As described above, in the embodiment of the present invention, the focus adjustment is performed for the alignment sensor 16 by using the fiducial mark FM which has the constant reflectance and the high contrast and which is disposed at the position optically conjugate with the reference plane Ra of the reticle R with respect to the projection optical system 9. Therefore, the fiducial mark FM can be measured with ease without requiring any management depending on the reflectance of the reticle. The focus adjustment can be performed highly accurately without causing any defocus. As a result, the reticle R and the wafer W can be positionally adjusted highly accurately.

In the embodiment of the present invention, the focus adjustment is carried out by once determining the relative positional relationship between the fiducial mark FM and the reticle fiducial mark RFM in the mode of Sequence B, and then observing the reticle fiducial mark RFM again. Therefore, it is unnecessary to drive the wafer stage 10, and it is possible to improve the throughput concerning the focus adjustment. Further, in the embodiment of the present invention, the focus adjustment for the alignment sensor 16 can be carried out concurrently with the exchange of the wafer W. It is possible to contribute to the improvement in the throughput concerning the exposure process, i.e., the device production process. Further, in the embodiment of the present invention, Sequences A and B are selectable in accordance with the result of comparison of the throughput depending on the exposure recipe. Therefore, it is possible to execute the optimum sequence depending on the number of lots, the number of reticles to be used, and the required accuracy. Thus, it is possible to greatly improve the versatile applicability.

In the exposure method based on the use of the focusing method and the position-measuring method as described above, it is possible to improve the overlay accuracy and it is possible to improve the productivity even when circuit patterns are overlaid in a plurality of layers on the wafer W, by performing the highly accurate positional adjustment for the reticle R and the wafer W. Therefore, as for the device which is produced by means of this exposure process, it is possible to greatly suppress the deterioration of quality which would be otherwise caused by any overlay error, and it is possible to realize the decrease in cost owing to the improvement in productivity.

When a detecting beam, which has a wavelength different from that of the exposure light beam, is used as the alignment illumination light beam, it is necessary that a correcting optical element, which corrects any chromatic aberration brought about in the projection optical system 9, is arranged at a position between the reticle R and the projection optical system 9 or at a position in the vicinity of the pupil plane of the projection optical system 9. However, in the embodiment of the present invention, it is unnecessary to provide such an optical element, because the mark position is measured with the detecting beam which has approximately the same wavelength as that of the exposure light beam. Thus, it is also possible to realize a compact size and a low price of the apparatus.

Sequence B in the embodiment described above adopts such a procedure that the relative positional relationship between the fiducial mark FM and the reticle fiducial mark RFM is determined in the correlated manner, and then the reticle fiducial mark RFM is observed again. However, there is no limitation thereto. For example, the following procedure may be adopted. That is, the relative positional relationship between the measuring plane of the reticle (or the alignment mark formed thereon) and the reticle fiducial mark RFM is previously determined in a correlated manner, and the reticle fiducial mark RFM is observed again. In this procedure, it is necessary to perform any management, for example, such that the position of the wafer stage 10 is controlled when the alignment mark formed on the reticle is measured. However, it is possible to contribute to the improvement in the throughput concerning the focus adjustment, the exposure process, and the device production process in the same manner as in the case in which Sequence B is executed.

The embodiment described above is constructed such that the detecting beam, which has approximately the same wavelength as that of the exposure light beam, is used as the alignment light beam. However, the present invention is not necessarily limited thereto. A beam having another wavelength may be used by employing the correcting optical element as described above.

The embodiment described above has been explained assuming that the focusing method and the position-measuring method of the present invention are used for the exposure process. However, the present invention is applicable to a variety of measuring processes in which the measurement is performed after adjusting the focusing position.

The substrate, which is applicable to the embodiment of the present invention, is not limited to only the semiconductor wafer W for producing the semiconductor device. Other than the above, it is possible to apply, for example, glass substrates for display devices, ceramic wafers for thin film magnetic heads, and master plates (synthetic quartz or silicon wafer) for masks or reticles to be used for the exposure apparatus.

Those applicable as the exposure apparatus 1 include the scanning type exposure apparatus based on the step-and-scan system (scanning stepper, U.S. Pat. No. 5,473,410) in which the reticle R and the wafer W are synchronously moved to perform the scanning exposure with the pattern on the reticle R as well as the projection exposure apparatus based on the step-and-repeat system (stepper) in which the exposure is performed with the pattern on the reticle R in a state in which the reticle R and the wafer W stand still and the wafer W is successively moved in a stepping manner. The content of U.S. Pat. No. 5,473,410 has been incorporated hereto by reference. The present invention is also applicable to the exposure apparatus based on the step-and-stitch system in which the transfer is performed with at least two patterns partially overlapped on the wafer W. Further, the invention may apply to a double stage system disclosed in U.S. Pat. No. 6,400,441 B1, the content of which has been incorporated hereinto by reference.

The type of the exposure apparatus 1 is not limited to the exposure apparatus for producing the semiconductor device in which the wafer W is exposed with the semiconductor device pattern. The present invention is widely applicable, for example, to the exposure apparatus for producing the liquid crystal display element or producing the display, and the exposure apparatus for producing the thin film magnetic head, the image pickup device (CCD), the reticle, and the mask.

Those usable as the light source 2 include the bright line (g-ray (436 nm)), the h-ray (404 nm), the i-ray (365 nm), the KrF excimer laser (248 nm), the ArF excimer laser (193 nm), the F₂ laser (157 nm), and the Ar₂ laser (126 nm) as well as the charged particle beam such as the electron beam and the ion beam. For example, when the electron beam is used, those usable as the electron gun include tantalum (Ta) and lanthanum hexaboride (LaB₆) of the electron emission type. Further, the high harmonic wave such as the YAG laser and the semiconductor laser may be used.

For example, it is allowable to use, as the exposure light beam, a high harmonic wave obtained such that a single wavelength laser in the infrared region or the visible region, which is oscillated from a DFB semiconductor laser or a fiber laser, is amplified with a fiber amplifier doped with, for example, erbium (or both of erbium and ytterbium), and the laser is subjected to wave conversion into an ultraviolet light beam by using nonlinear optical crystal. When the oscillation wavelength of the single wavelength laser is within a range of 1.544 to 1.553 μm, it is possible to obtain an 8-fold high harmonic wave within a range of 193 to 194 nm, i.e., an ultraviolet light beam having approximately the same wavelength as that of the ArF excimer laser. When the oscillation wavelength is within a range of 1.57 to 1.58 μm, it is possible to obtain a 10-fold high harmonic wave within a range of 157 to 158 nm, i.e., an ultraviolet light beam having approximately the same wavelength as that of the F₂ laser.

It is also allowable to use, as the exposure light beam, an EUV (Extreme Ultra Violet) light beam in the soft X-ray region having a wavelength of about 5 to 50 nm, for example, having a wavelength of 13.4 nm or 11.5 nm emitted from a laser plasma light source or SOR. In the EUV exposure apparatus, a reflection type reticle is used, and the projection optical system is a reduction system comprising only a plurality of (for example, 3 to 6 pieces of) reflecting optical elements (mirrors).

The projection optical system 9 is not limited to one based on the reduction system, which may be any one of those based on the 1× unity magnification system or the magnification system. Further, the projection optical system 9 may be any one of those based on the refraction system, the reflection system, and the cata-dioptric system. When the wavelength of the exposure light beam is not more than about 200 nm, it is desirable that the optical path, through which the exposure light beam passes, is purged with a gas (inert gas such as nitrogen and helium) which scarcely absorbs the exposure light beam. When the electron beam is used, an electronic optical system, which comprises an electronic lens and a deflector, may be used as the optical system. It goes without saying that the optical path, through which the electron beam passes, is in a vacuum state.

When a linear motor (see U.S. Pat. No. 5,623,853 or U.S. Pat. No. 5,528,118) is used for the wafer stage 10 and/or the reticle stage 20, it is allowable to use any one of the air-floating type based on the use of the air bearing and the magnetic floating type based on the use of the Lorentz's force or the reactance force. The respective stages 10, 20 may be of the type in which the stage is movable along a guide or of the guideless type in which no guide is provided.

As for the driving mechanism for each of the stages 10, 20, it is also allowable to use a plane motor comprising a magnet unit including a magnet arranged two-dimensionally and an armature unit including a coil arranged two-dimensionally, the magnet unit and the armature unit being opposed to one another so that each of the stages 10, 20 is driven by means of the electromagnetic force. In this arrangement, any one of the magnet unit and the armature unit may be connected to the stage 10, 20, and the other of the magnet unit and the armature unit may be provided on the side of the movement surface of the stage 10, 20.

The reaction force, which is generated by the movement of the wafer stage 10, may be mechanically released to the floor (ground) by using a frame member so that the reaction force is not transmitted to the projection optical system 9 as described in Japanese Patent Application Laid-open No. 8-166475 and corresponding U.S. Pat. No. 5,528,118, the content of which is incorporated hereinto by reference.

The reaction force, which is generated by the movement of the reticle stage 20, may be mechanically released to the floor (ground) by using a frame member so that the reaction force is not transmitted to the projection optical system 9 as described in Japanese Patent Application Laid-open No. 8-330224 and corresponding U.S. Pat. No. 5,874,820, the content of which is incorporated hereinto by reference.

As described above, the exposure apparatus 1 according to the embodiment of the present invention is produced by assembling various subsystems including the respective constitutive elements as defined in claims so as to maintain predetermined mechanical accuracies, electric accuracies, and optical accuracies. In order to assure the various types of accuracies, the various optical systems are adjusted to achieve the optical accuracy, the various mechanical systems are adjusted to achieve the mechanical accuracy, and the various electric systems are adjusted to achieve the electric accuracy before and after the assembling. The steps of assembling the various subsystems into the exposure apparatus include, for example, mechanical connection of the various subsystems to one another, wiring connection of electric circuits, and piping connection of gas pressure circuits. It goes without saying that the steps of individually assembling the respective subsystems are performed before the steps of assembling the various subsystems into the exposure apparatus. When the steps of assembling the various subsystems into the exposure apparatus are completed, the overall adjustment is performed to secure the various accuracies as the entire exposure apparatus. It is desirable that the exposure apparatus is produced in a clean room in which, for example, the temperature and the degree of cleanness are managed.

As explained above, the focusing method according to the present invention is a procedure comprising the step of adjusting the second object to the position which is optically conjugate with the first object with respect to the first optical system, and the step of adjusting the focusing position of the second optical system to the second object via the first optical system. Accordingly, in this focusing method, the focusing position of the second optical system can be adjusted to the second object having the constant reflectance without requiring such management that the underlying base reflectance is selected depending on the reflectance of the first object. Therefore, an effect is obtained such that the highly accurate focus adjustment can be carried out without causing any defocus.

The focusing method according to the present invention may comprise the step of adjusting the focusing position of the second optical system to the first reference member which is arranged in substantially the same plane as the first object and which is different from the first object. Accordingly, the focusing position of the second optical system can be adjusted to the predetermined plane of the first reference plane having the constant reflectance irrelevant to the reflectance of the predetermined plane on the first object. Therefore, the highly accurate focus adjustment can be carried out without causing any defocus, and it is possible to contribute to the improvement in throughput, because it is unnecessary to position the second object at the predetermined position during the focus adjustment.

In the focusing method, it is possible to select the step of adjusting the focusing position of the second optical system to the second object again after adjusting the focusing position of the second optical system to the second object, and the step of adjusting the focusing position of the second optical system to the first reference member after adjusting the focusing position of the second optical system to the predetermined plane of the second object. Accordingly, an effect is obtained such that it is possible to execute the optimum sequence depending on the number of lots and the required accuracy, and it is possible to greatly improve the versatile applicability.

In the focusing method, the first focusing position data of the second optical system obtained when the focusing position of the second optical system is adjusted to the second object and the second focusing position data of the second optical system obtained when the focusing position of the second optical system is adjusted to the first reference member are stored, and then the focusing position of the second optical system is adjusted to the first reference member again so that the readjusted focusing position of the second optical system may be moved depending on the stored first and second focusing position data. Accordingly, an effect is obtained such that it is unnecessary to drive the stage, and it is possible to improve the throughput concerning the focus adjustment.

The position-measuring method according to the present invention comprises the step of adjusting the second object to the position which is optically conjugate with the first object with respect to the first optical system, and the step of adjusting the focusing position of the second optical system to the second object via the first optical system. Accordingly, in this position-measuring method, the focus adjustment can be carried out highly accurately irrelevant to the reflection characteristics of the first object, and it is possible to avoid inconveniences such as the deterioration of repeatability of the measurement, which would be otherwise caused by the defocus.

The position-measuring method may further comprise the step of adjusting the focusing position of the second optical system to the first reference member which is different from the first object and which is arranged in substantially the same plane as the first object. Accordingly, the focusing position of the second optical system can be adjusted to the first reference member having the constant reflectance irrelevant to the reflectance of the first object. Therefore, it is possible to carry out the highly accurate position measurement without causing any defocus.

In the position-measuring method, the step of adjusting the focusing position of the second optical system to the second object again after adjusting the focusing position of the second optical system to the second object, and the step of adjusting the focusing position of the second optical system to the first reference member after adjusting the focusing position of the second optical system to the predetermined plane of the second object may be selected. Accordingly, an effect is obtained such that it is possible to execute the optimum sequence depending on the number of lots and the required accuracy, and it is possible to greatly improve the versatile applicability.

In the position-measuring method, the first focusing position data of the second optical system obtained when the focusing position of the second optical system is adjusted to the second object, and the second focusing position data of the second optical system obtained when the focusing position of the second optical system is adjusted to the first reference member may be stored; the focusing position of the second optical system may be thereafter adjusted to the first reference member again; and the focusing position of the second optical system having been adjusted again may be moved depending on the stored first and second focusing position data. Accordingly, an effect is obtained such that it is unnecessary to drive the wafer stage when the focusing position of the second optical system is adjusted before starting the position measurement, and it is possible to improve the throughput concerning the focus adjustment.

In the position-measuring method, the relative position information about the first object and the second object may be measured. Accordingly, it is possible to positionally adjust the first object and the second object highly accurately.

In the position-measuring method, the second object may be the second reference member secured on the movable stage. Accordingly, the focusing position of the second optical system can be adjusted highly accurately on the basis of the second reference member. Therefore, it is possible to measure the position of the first object highly accurately.

In the position-measuring method, the relative position information about the first object and the second reference member may be measured. Accordingly, the relative positional relationship between the first object and the second object can be measured highly accurately by the second optical system.

In the position-measuring method, the first object may be the mask which has the pattern; and the second object may be the substrate to which the pattern is transferred by the first optical system. Accordingly, the focusing position of the second optical system can be adjusted highly accurately on the basis of the substrate. Therefore, it is possible to measure the position of the mask highly accurately.

In the position-measuring method, the relative position information about the mask and the substrate may be measured. Accordingly, the relative positional relationship between the mask and the substrate can be measured highly accurately by the second optical system.

The exposure method of the present invention comprises the step of adjusting the second object to the position which is optically conjugate with the first object with respect to the first optical system; and the step of adjusting the focusing position of the second optical system to the second object via the first optical system. Accordingly, the focus adjustment can be carried out highly accurately for the second optical system irrelevant to the reflection characteristics of the first object. The first object can be observed without any defocus to perform the exposure.

The exposure method may comprise the step of adjusting the focusing position of the second optical system to the first reference member which is different from the first object and which is arranged in substantially the same plane as the plane of the first object on which the pattern is formed. Accordingly, the focusing position of the second optical system can be adjusted to the first reference member having the constant reflectance irrelevant to the reflectance of the first object. Therefore, the first object can be observed highly accurately to perform the exposure without causing any defocus.

In the exposure method, the first focusing position data of the second optical system obtained when the focusing position of the second optical system is adjusted to the second object, and the second focusing position data of the second optical system obtained when the focusing position of the second optical system is adjusted to the first reference member may be stored; the focusing position of the second optical system may be thereafter adjusted to the first reference member again; and the focusing position of the second optical system having been adjusted again may be moved depending on the stored first and second focusing position data. Accordingly, when the focusing position of the second optical system is adjusted before starting the position measurement, it is unnecessary to drive the wafer stage. Thus, it is possible to improve the throughput concerning the focus adjustment.

In the exposure method, the relative position information about the first object and the second object may be measured by using the second optical system. Accordingly, the first object and the second object can be positionally adjusted highly accurately to perform the exposure.

In the exposure method, the relative position information about the first object and the second object may be measured by using the beam which has substantially the same wavelength as that of the exposure light beam to be used for the exposure. Accordingly, it is unnecessary to provide any correcting optical element for the chromatic aberration. It is possible to realize the compact size and the low price of the apparatus.

In the exposure method, the second object may be the substrate which is exposed with the pattern via the first optical system. Accordingly, the focusing position of the second optical system can be adjusted on the substrate to perform the exposure, and the distance of movement of the stage can be shortened. Thus, it is possible to improve the throughput.

In the exposure method, the second object may be the second reference member secured on the movable stage. Accordingly, the focusing position of the second optical system can be adjusted highly accurately on the basis of the second reference member. Therefore, the first object can be observed without any defocus to perform the exposure.

In the exposure method, the second optical system may measure the relative position information about the first object and the substrate to which the pattern is transferred via the first optical system. Accordingly, the first object and the substrate can be positionally adjusted highly accurately to perform the exposure.

In the exposure method, the relative position information about the first object and the substrate may be measured with the beam which has substantially the same wavelength as that of the exposure light beam to be used for the exposure. Accordingly, in this exposure method, it is unnecessary to provide any correcting optical element for the chromatic aberration. It is possible to realize the compact size and the low price of the apparatus.

The method for producing the device of the present invention comprises the step of adjusting the second object to the position which is optically conjugate with the first object with respect to the first optical system; and the step of adjusting the focusing position of the second optical system to the second object via the first optical system. Accordingly, the focus adjustment can be carried out highly accurately irrelevant to the reflection characteristics of the first object, and it is possible to greatly suppress the deterioration of quality which would be otherwise caused by the defocus of the second optical system. Further, it is possible to realize the decrease in cost owing to the improvement in productivity.

The exposure apparatus of the present invention is an exposure apparatus for performing the exposure with the pattern formed on the first object via the first optical system; the exposure apparatus comprising the second optical system which observes the first object and which is capable of observing the second object via the first object and the first optical system; the stage which holds the second object and which positions the second object at the position conjugate with the first object with respect to the first optical system; and the alignment control system which adjusts the focusing position of the second optical system to the second object. Accordingly, the focus adjustment can be carried out for the second optical system highly accurately irrelevant to the reflection characteristics of the first object. The first object can be observed without any defocus to perform the exposure.

In the exposure apparatus, the second optical system may have the internal focusing system lens which adjusts the focusing position of the second optical system, and the internal focusing system lens position-detecting unit which detects the position of the internal focusing system lens; and the apparatus may further comprise the storage unit which stores position data of the internal focusing system lens detected by the internal focusing system lens position-detecting unit. Accordingly, the focusing position of the second optical system can be adjusted, and the position can be measured and stored. Therefore, the focusing position can be reproduced later on. Further, it is also possible to perform the offset management on the basis of the predetermined reference.

The exposure apparatus may further comprise the first reference member which is formed with the reference plane belonging to substantially the same plane as the pattern plane of the first object; wherein the alignment control system may move the focusing position depending on the position data of the internal focusing system lens stored in the storage unit after focusing the focusing position of the second optical system to the reference plane of the first reference member. Accordingly, the focusing position of the second optical system can be reproduced highly accurately on the basis of the first reference member.

In the exposure apparatus, the second optical system may measure the relative position information about the first object and the second object. Accordingly, the positions of the first object and the second object can be measured by using the second optical system for which the focusing position is adjusted. Therefore, the first object and the second object can be positionally adjusted highly accurately.

What is claimed is:

1. A focusing method for adjusting, to a first object, a focusing position of a second optical system which observes the first object and which is capable of observing a second object via the first object and a first optical system, the focusing method comprising the steps of:
adjusting the second object to a position which is optically conjugate with the first object with respect to the first optical system; and
adjusting the focusing position of the second optical system to the second object via the first optical system.

2. The focusing method according to claim 1, further comprising a step of adjusting the focusing position of the second optical system to a first reference member which is different from the first object and which is arranged in substantially the same plane as the first object.

3. The focusing method according to claim 2, wherein it is possible to select:
a step of adjusting the focusing position of the second optical system to the second object again after adjusting the focusing position of the second optical system to the second object; and
a step of adjusting the focusing position of the second optical system to the first reference member after adjusting the focusing position of the second optical system to the second object.

4. The focusing method according to claim 2, further comprising the steps of:
storing first focusing position data of the second optical system obtained when the focusing position of the second optical system is adjusted to the second object, and second focusing position data of the second optical system obtained when the focusing position of the second optical system is adjusted to the first reference member;
adjusting the focusing position of the second optical system to the first reference member again after storing the first and second focusing position data; and
moving the focusing position of the second optical system having been adjusted again, depending on the stored first and second focusing position data.

5. A position-measuring method for measuring position information about a first object with a second optical system which observes the first object and which is capable of observing a second object via the first object and a first optical system, the position-measuring method comprising:
a step of adjusting the second object to a position which is optically conjugate with the first object with respect to the first optical system; and
a step of adjusting a focusing position of the second optical system to the second object via the first optical system.

6. The position-measuring method according to claim 5, further comprising a step of adjusting the focusing position of the second optical system to a first reference member which is different from the first object and which is arranged in substantially the same plane as the first object.

7. The position-measuring method according to claim 6, wherein it is possible to select:
a step of adjusting the focusing position of the second optical system to the second object again after adjusting the focusing position of the second optical system to the second object; and
a step of adjusting the focusing position of the second optical system to the first reference member after adjusting the focusing position of the second optical system to the second object.

8. The position-measuring method according to claim 6, further comprising the steps of:
storing first focusing position data of the second optical system obtained when the focusing position of the second optical system is adjusted to the second object, and second focusing position data of the second optical system obtained when the focusing position of the second optical system is adjusted to the first reference member;
adjusting the focusing position of the second optical system to the first reference member again after storing the first and second focusing position data; and
moving the focusing position of the second optical system having been adjusted again, depending on the stored first and second focusing position data.

9. The position-measuring method according to claim 5, wherein the position information about the first object is relative position information about the first object and the second object.

10. The position-measuring method according to claim 5, wherein the second object is a second reference member secured on a movable stage.

11. The position-measuring method according to claim 10, wherein the position information about the first object is relative position information about the first object and the second reference member.

12. The position-measuring method according to claim 5, wherein:
the first object is a mask which has a pattern; and
the second object is a substrate to which the pattern is transferred by the first optical system.

13. The position-measuring method according to claim 12, wherein the position information about the mask is relative position information about the mask and the substrate.

14. An exposure method for performing exposure with a pattern formed on a first object via a first optical system, the exposure method comprising the steps of:
adjusting a second object to a position which is optically conjugate with the pattern on the first object with respect to the first optical system; and
adjusting a focusing position of a second optical system which observes the first object and which is capable of observing the second object via the first object and the first optical system, to the second object via the first optical system.

15. The exposure method according to claim 14, further comprising a step of adjusting the focusing position of the second optical system to a first reference member which is different from the first object and which is arranged in substantially the same plane as a plane of the first object on which the pattern is formed.

16. The exposure method according to claim 15, further comprising the steps of:
storing first focusing position data of the second optical system obtained when the focusing position of the second optical system is adjusted to the second object, and second focusing position data of the second optical system obtained when the focusing position of the second optical system is adjusted to the first reference member;
adjusting the focusing position of the second optical system to the first reference member again after storing the first and second focusing position data; and
moving the focusing position of the second optical system having been adjusted again, depending on the stored first and second focusing position data.

17. The exposure method according to claim 14, further comprising a step of measuring relative position information about the first object and the second object by the second optical system.

18. The exposure method according to claim 17, wherein the relative position information is measured by a beam which has substantially the same wavelength as that of an exposure light beam to be used for the exposure with the pattern.

19. The exposure method according to claim 14, wherein the second object is a substrate which is exposed with the pattern via the first optical system.

20. The exposure method according to claim 14, wherein the second object is a second reference member secured on a movable stage.

21. The exposure method according to claim 20, further comprising a step of measuring relative position information about the first object and a substrate to which the pattern is transferred via the first optical system, by the second optical system.

22. The exposure method according to claim 21, wherein the relative position information is measured with a beam which has substantially the same wavelength as that of an exposure light beam to be used for the exposure with the pattern.

23. A method for producing a device by transferring a device pattern formed on a first object via a first optical system, the method comprising the steps of:
adjusting a second object to a position which is optically conjugate with the first object with respect to the first optical system; and
adjusting a focusing position of a second optical system which observes the first object and which is capable of observing the second object via the first object and the first optical system, to the second object via the first optical system.

24. An exposure apparatus for performing exposure with a pattern formed on a first object via a first optical system, the exposure apparatus comprising:
a second optical system which observes the first object and which is capable of observing a second object via the first object and the first optical system;
a stage which holds the second object and which positions the second object at a position conjugate with the first object with respect to the first optical system; and
an alignment control system which adjusts a focusing position of the second optical system to the second object.

25. The exposure apparatus according to claim 24, wherein:
the second optical system has an internal focusing system lens which adjusts the focusing position of the second optical system, and an internal focusing system lens position-detecting unit which detects a position of the internal focusing system lens; and
the apparatus further comprises a storage unit which stores position data of the internal focusing system lens detected by the internal focusing system lens position-detecting unit.

26. The exposure apparatus according to claim 25, further comprising:
a first reference member which is formed with a reference plane belonging to substantially the same plane as a pattern plane of the first object, wherein:
the alignment control system moves the focusing position depending on the position data of the internal focusing system lens stored in the storage unit after focusing the focusing position of the second optical system to the reference plane of the first reference member.

27. The exposure apparatus according to claim 24, wherein the second optical system measures relative position information about the first object and the second object.
